(19) United States
(12) Patent Application Publication
(10) Pub. No.: US 2006/0139953 A1
(43) Pub. Date: Jun. 29, 2006

(54) Liquid crystal display and backlight module thereof

(75) Inventors: Yen-Chun Chou, Taipei County (TW); Chung-Mo Chiu, Taipei (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 11/081,562

(22) Filed: Mar. 17, 2005

(30) Foreign Application Priority Data
Dec. 24, 2004 (TW) 093140684

(51) Int. Cl. F21V 7/04

(52) U.S. Cl. 362/613

(57) ABSTRACT

A backlight module includes an optical film substrate and a plurality of light sources. The optical film substrate has a first surface and a second surface opposite to the first surface. The first surface of the optical film substrate has a plurality of Fresnel areas. The Fresnel areas are disposed on the first surface in an array arrangement. The light sources are disposed at one side of the optical film substrate. In addition, a liquid crystal display including the backlight module is provided.

### BACKGROUND OF THE INVENTION

1. Field of Invention

The invention relates to a display and a backlight module, and, in particular, to a liquid crystal display and a backlight module thereof.

2. Related Art

In the coming multimedia age, the usable displays have been developed and have various types. In the present displays, flat panel displays have the advantages of light weight and thinner thickness, so that they are one of the mainstreams in this industry.

Regarding to the flat panel displays, the liquid crystal display has the advantages of full color, high resolution, thinner thickness, power saving and high contrast, so it has broader application fields. For example, the application fields of the liquid crystal display include small area applications such as the mobile phone screen and the display panel in car, middle size applications such as the monitor of a laptop computer or a desktop computer, and the latest large size applications such as the LCD TV.

With reference to FIG. 1, the present large-sized liquid crystal display 1 includes a liquid crystal panel 11 and a backlight module 12. The backlight module 12 mainly includes a prism unit 121, a diffuser 122, a light source 123, a reflection layer 124 and a case 125. The light emitted from the light source 123 is reflected by the reflection layer 124, and is then transmitted towards the diffuser 122. The light passes through the diffuser 122 and the prism unit 121 in sequence, and is then projected to the liquid crystal panel 11. Finally, the liquid crystal cells of the liquid crystal panel 11 control the transmission time and transmission orders so as to present the image for the viewer.

In general, the light source 123 of the liquid crystal device 1 is usually a cold cathode fluorescent lamp (CCFL), a hot cathode fluorescent lamp or a planar lamp. However, accompanying with the progressive of light-emitting diodes (LED), the novel LED has the advantages of superior life time, power saving, lower operation voltage, high color rendering, low-temperature operation, fast response speed, and matching environmental protection requests (mercury-free). These advantages of LED are superior to the present CCFL. Thus, it is a trend with using the LED array light source including several LEDs to replace the conventional light sources, CCFL, in the liquid crystal display.

However, the LCD array light source includes a plurality of LEDs in an array arrangement, and the LED is a high brightness light source. Therefore, the intervals between every two neighbor LEDs may show dark zones, which affect the uniformity of the entire device.

In addition, since the prism unit 121 of the conventional liquid crystal display 1 is composed of a plurality of prisms with the same dimension, shape, and angle, the light passing through the prism unit 121 can be converged so as to increase the brightness of the liquid crystal display 1. Besides, since the prism of the prism unit 121 are all with the same shape and angle, the light converging abilities are constant. Therefore, in order to satisfy the demand of the wider viewing angle, the conventional liquid crystal display 1 has the problem of insufficient central brightness caused by that the emitted light is distributed for the wide viewing angle. Otherwise, in order to satisfy the demand of central brightness, the consideration of viewing angle must be sacrificed so that the demand of wide viewing angle may not be achieved.

It is therefore an important subject of the invention to provide a liquid crystal display and a backlight module thereof for solving the above-mentioned problems.

### SUMMARY OF THE INVENTION

In view of the foregoing, the invention is to provide a liquid crystal display and a backlight module thereof, which can equalize the light emitted from the light sources and can control the angle and direction of the emitted light.

To achieve the above, a backlight module of the invention includes an optical film substrate and a plurality of light sources. In the invention, the optical film substrate has a first surface and a second surface opposite to the first surface. The first surface has a plurality of Fresnel areas, which are located on the first surface in an array arrangement. The light sources are disposed at one side of the optical film substrate.

In addition, the invention also discloses a liquid crystal display, which includes a liquid crystal panel, an optical film substrate and a plurality of light sources. The optical film substrate has a first surface and a second surface opposite to the first surface. The first surface has a plurality of Fresnel areas, which are located on the first surface in an array arrangement. The light sources are disposed at one side of the optical film substrate, so that the optical film substrate is located between the liquid crystal panel and the light sources.

As mentioned above, the liquid crystal display and backlight module of the invention can equalize the light emitted from the light sources and can control the angle and direction of the emitted light. Comparing with the prior art, the invention utilizes a plurality of Fresnel areas to adjust the angle and direction of the emitted light, which can achieve the demands of brightness and viewing angle under different conditions. Accordingly, the liquid crystal display of the invention can achieve the demands of wide viewing angle and high brightness. In addition, since the invention can control the angle and direction of the emitted light, the dark zones at the intervals between every two neighbor conventional LEDs can be prevented. Thus, the light uniformity of the liquid crystal display of the invention can be improved.

### BRIEF DESCRIPTION OF THE DRAWINGS

The invention will become more fully understood from the detailed description given herein below illustration only, and thus is not limitative of the present invention, and wherein:

FIG. 1 is a schematic view showing a large size liquid crystal display;

FIG. 2A is an exploded view showing a backlight module according to a preferred embodiment of the invention;

FIG. 2B is a cross-sectional view of the backlight module shown in FIG. 2A;

FIG. 3 is a schematic view showing another backlight module according to the preferred embodiment of the invention;

FIGS. 4 and 5 are schematic views showing still another backlight module according to the preferred embodiment of the invention;

FIG. 6 is a schematic view showing another aspect of an optical film substrate according to the preferred embodiment of the invention; and

FIG. 7 is a schematic view showing a liquid crystal display according to the preferred embodiment of the invention.

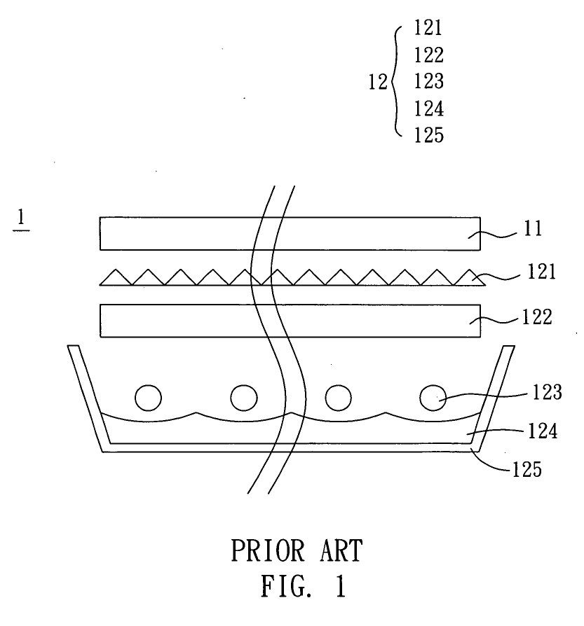

### DETAILED DESCRIPTION OF THE INVENTION

The present invention will be apparent from the following detailed description, which proceeds with reference to the accompanying drawings, wherein the same references relate to the same elements.

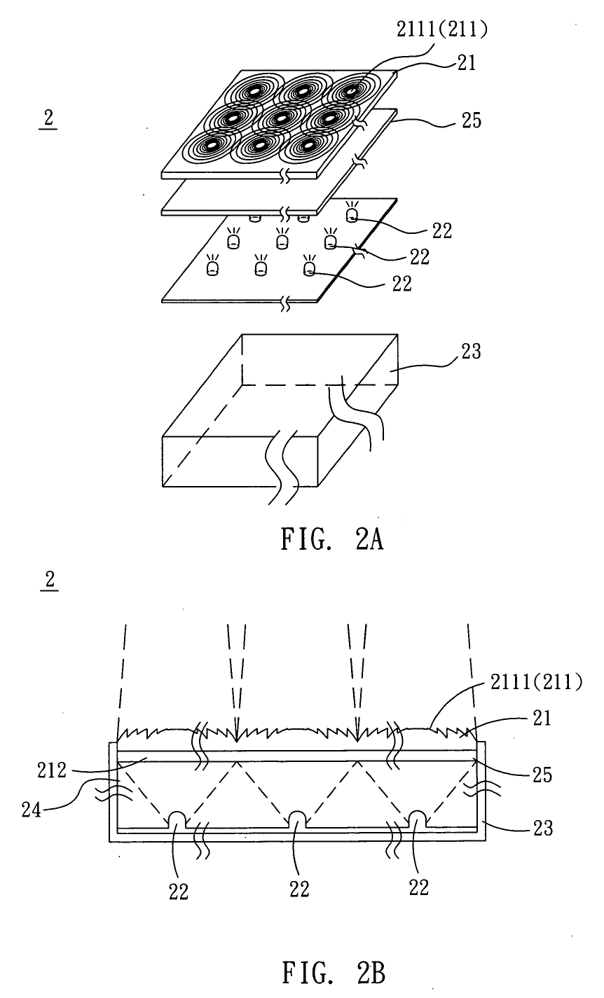

With reference to FIGS. 2A and 2B, a backlight module 2 according to a preferred embodiment of the invention includes an optical film substrate 21 and a plurality of light sources 22. In the embodiment, the optical film substrate 21 has a first surface 211 and a second surface 212 opposite to the first surface 211. The first surface 211 has a plurality of Fresnel areas 2111. In the present embodiment, the Fresnel areas 2111 are located on the first surface 211 in an array arrangement.

A plurality of light sources 22 are disposed at one side of the optical film substrate 21. In this embodiment, the light sources 22 are light-emitting diodes (LEDs) and the light sources 22 are located facing to the first surface 211 in an array arrangement so as to provide an LED array. In addition, each light source 22 is corresponding to at least one of the Fresnel areas 2111.

Referring to FIG. 2B, the backlight module 2 further includes a case 23, which has an opening. The optical film substrate 21 is jointed with the opening, and the optical film substrate 21 and the case 23 form an accommodating space 24. The light sources 22 are disposed in the case 23 and are located in the accommodating space 24.

In the present embodiment, the optical film substrate 21 can be a flexible substrate or a rigid substrate. For example, the optical film substrate 21 can be a plastic substrate or a glass substrate. The flexible substrate and plastic substrate can be made of polycarbonate (PC), polyester (PET), cyclic olefin copolymer (COC), metallocene-based cyclic olefin copolymer (mCOC), or the likes.

As shown in FIG. 2B, the first surface 211 of the optical film substrate 21 has a plurality of Fresnel areas 2111. Each Fresnel area 2111 has at least one focal length. In this case, the Fresnel area 2111 has a single focal length. When the light passes through the Fresnel areas 2111, the diverging or converging angle of the light relates to the relative positions of the light sources 22 and the Fresnel areas 2111. To be noted the light path as shown in FIG. 2B is illustrated only as an example, and the usable light paths according to the embodiment should not be limited in the shown light path.

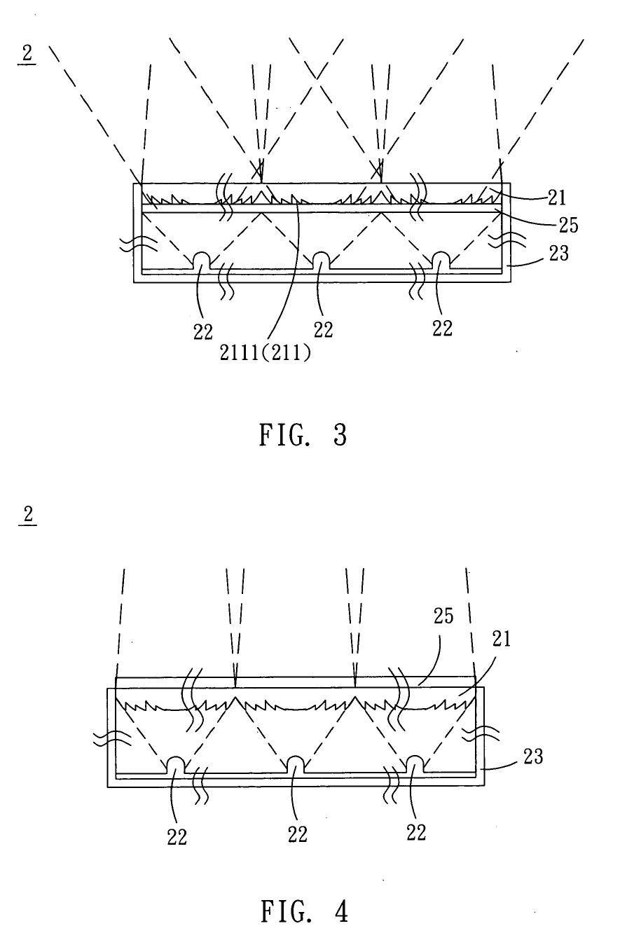

Alternatively, with reference to FIG. 3, the Fresnel area 2111 may have two focal lengths. In this case, since the Fresnel area 2111 has two focal lengths, a part of the light emitted from the light sources 22 is converged in the central area of the Fresnel area 2111, and the other part of the light is diverged through the edges of the Fresnel area 2111. Thus, the brightness at the intervals between every two light sources 22 can be compensated.

In the current embodiment, each light source 22 is corresponding to one of the Fresnel areas 2111, and is disposed adjacent to the center of each Fresnel area 2111. In other words, the number of the light sources 22 is the same as that of the Fresnel areas 2111. To be noted, the invention is not limited to this case that the light sources 22 and the Fresnel areas 2111 are corresponding to each other one by one. In practice, the light sources 22 and the Fresnel areas 2111 may correspond to each other by way of multiple to single or single to multiple.

With reference to FIG. 2B again, the second surface 212 of the optical film substrate 21 and the light sources 22 face to each other. Of course, as shown in FIG. 3, the first surface 211 of the optical film substrate may face to the light sources 22.

Furthermore, the backlight module 2 of the embodiment may be doped with diffusion particles. In the present embodiment, the diffusion particles are doped in the optical film substrate 21. The configuration of the diffusion particles may modify the progressing direction of light and can enhance the scattering process so as to achieve the nebulization effect.

As shown in FIGS. 2B and 3, the backlight module 2 may further include a diffuser 25, which is located between the optical film substrate 21 and the light sources 22. Of course, the diffuser 25 can be disposed adjacent to the optical film substrate 21 (not shown).

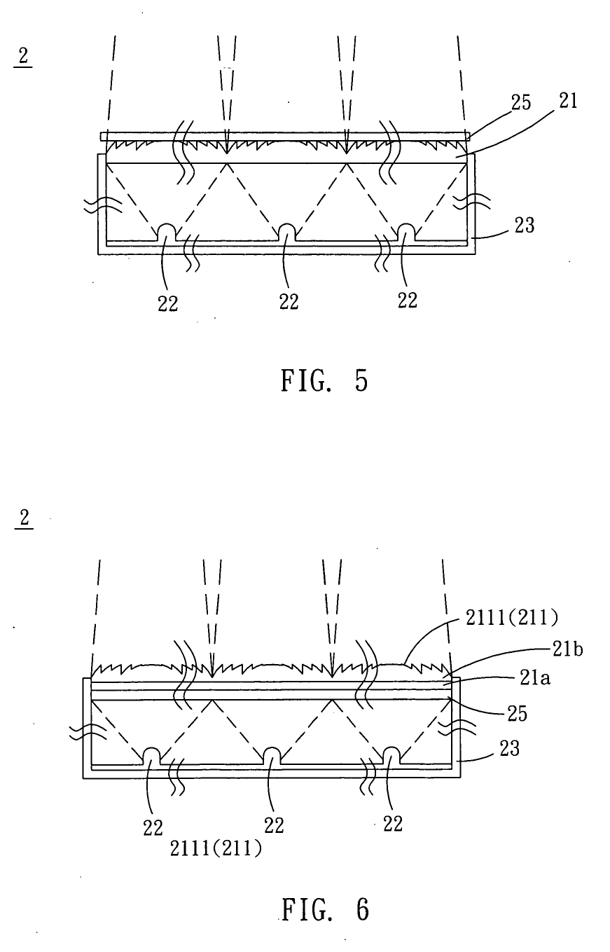

Moreover, as shown in FIGS. 4 and 5, the optical film substrate 21 is located between the light sources 22 and the diffuser 25. In this case, the diffuser 25 is disposed on the optical film substrate 21 (as shown in FIGS. 4 and 5). Of course, the diffuser 25 may be disposed underneath the optical film substrate 21 (not shown).

With reference to FIG. 6, which shows another aspect of an optical film substrate 21′ according to the embodiment of the invention, the optical film substrate 21′ includes a transparent substrate 21a and an optical film 21b. In the current embodiment, one surface of the optical film 21b has a plurality of Fresnel areas 2111, which are located on the first surface in an array arrangement. The other surface of the optical film 21b is attached to the transparent substrate 21a so as to form the optical film substrate 21′. In the present embodiment, the transparent substrate 21a can be any substrate that is light penetrable. For example, the transparent substrate 21a can be a flexible substrate or a rigid substrate. In particular, the transparent substrate 21 a can be a plastic substrate or a glass substrate.

In the embodiment, the transparent substrate 21a can be disposed between the optical film 21b and the diffuser 25. Herein, the diffuser 25 is installed underneath the transparent substrate 21a (as shown in FIG. 6). Of course, the diffuser 25 can be disposed adjacent to and above the transparent substrate 21a (not shown).

As mentioned above, the backlight module 2 of the embodiment can be and should not be limited to a backlight module of a liquid crystal display.

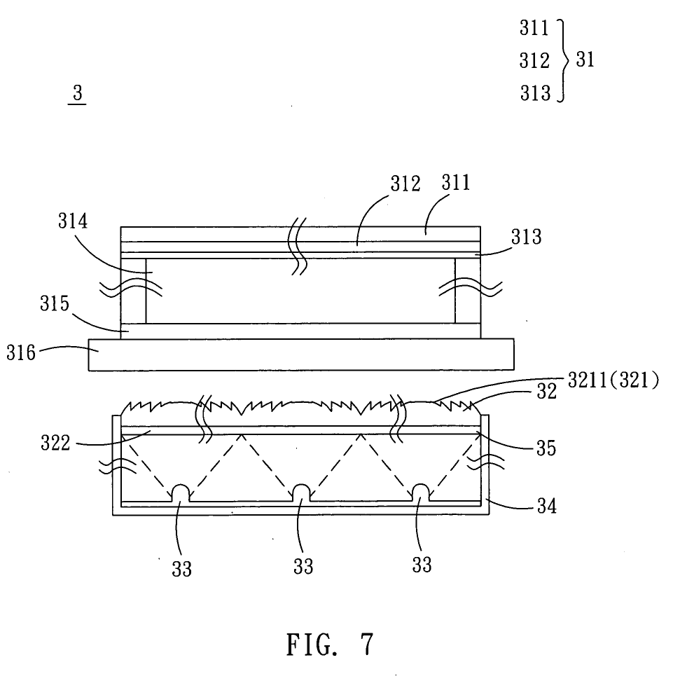

With reference to FIG. 7, a liquid crystal display 3 according to a preferred embodiment of the invention includes a liquid panel 31, an optical film substrate 32 and a plurality of light sources 33. The optical film substrate 32 has a first surface 321 and a second surface 322 opposite to the first surface 321. The first surface 321 has a plurality of Fresnel areas 3211. The light sources 33 are disposed at one side of the optical film substrate 32, and the optical film substrate 32 is located between the liquid crystal panel 31 and the light sources 33.

In the present embodiment, the liquid crystal display 3 further includes a case 34 and a diffuser 35.

The functions and features of the optical film substrate 32, light sources 33, case 34 and diffuser 35 are the same as those shown in FIG. 2B, so the detailed descriptions are omitted for concise purpose.

In addition, the liquid crystal panel 31 includes a first polarizer 311, a filter layer 312, a first electrode 313, a liquid crystal layer 314, a thin film transistor (TFT) circuit 315 and a second polarizer 316. To be noted, the component elements of the liquid crystal panel 31 can be adjusted based on the actual requirements.

As shown in FIG. 7, the light emitted from the light sources 33 passes through the diffuser 35 and the optical film substrate 32, and then achieves the liquid crystal panel 31. After that, the TFT circuit 315 controls the motion angle of each liquid crystal cell of the liquid crystal layer 314 so as to control the brightness and time of the passed light. Finally, the image can be formed and projected to the viewers.

In the embodiment, the Fresnel area 3211 has at least one focal length. If fresnel area 3211 has two focal lengths (as shown in FIG. 3), a part of the light emitted from the light sources 33 can be converged in the central area of the fresnel area 3211, and the other part of the light can be diverged through the edges of the fresnel area 3211. Thus, the brightness at the intervals between every two light sources 33 can be compensated. As a result, the liquid crystal display 3 of the invention has the advantages of wide viewing angle and high brightness.

In summary, the liquid crystal display and backlight module of the invention can equalize the light emitted from the light sources and can control the angle and direction of the emitted light. Comparing with the prior art, the invention utilizes a plurality of Fresnel areas to adjust the angle and direction of the emitted light, so that the demands of brightness and viewing angle can be achieved under different conditions. Accordingly, the liquid crystal display of the invention can achieve the demands of wide viewing angle and high brightness. In addition, since the invention can control the angle and direction of the emitted light, the dark zones at the intervals between every two neighbor conventional LEDs can be prevented. Thus, the light uniformity of the liquid crystal display of the invention can be improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backlight module, comprising:
an optical film substrate, which has a first surface and a second surface opposite to the first surface, wherein the first surface has a plurality of fresnel areas, and the fresnel areas are located on the first surface in an array arrangement; and
a plurality of light sources, which are disposed at one side of the optical film substrate.

2. The backlight module of claim 1, further comprising:
a case, which has an opening, wherein the optical film substrate is jointed with the opening, the optical film substrate and the case form an accommodating space, and the light sources are disposed in the accommodating space.

3. The backlight module of claim 1, wherein the first surface of the optical film substrate faces to the light sources.

4. The backlight module of claim 1, wherein the second surface of the optical film substrate faces to the light sources.

5. The backlight module of claim 1, wherein each of the Fresnel areas has a focal length.

6. The backlight module of claim 1, wherein each of the light sources is corresponding to one of the Fresnel areas.

7. The backlight module of claim 1, wherein each of the light sources is corresponding to at least one of the Fresnel areas.

8. The backlight module of claim I, wherein the light sources are a light-emitting diode (LED) array.

9. The backlight module of claim 1, wherein the optical film substrate comprises an optical film and a transparent substrate, and the optical film attaches to the transparent substrate.

10. The backlight module of claim 9, further comprising:
a diffuser, wherein the transparent substrate is located between the optical film and the diffuser.

11. The backlight module of claim 10, wherein the diffuser is disposed adjacent to the transparent substrate.

12. The backlight module of claim 1, further comprising:
a diffuser, wherein the optical film substrate is located between the light sources and the diffuser.

13. The backlight module of claim 12, wherein the diffuser is disposed adjacent to the optical film substrate.

14. A liquid crystal display, comprising:
a liquid crystal panel; and
a backlight module, which comprises:
an optical film substrate, which has a first surface and a second surface opposite to the first surface, wherein the first surface has a plurality of fresnel areas, and the fresnel areas are located on the first surface in an array arrangement; and
a plurality of light sources, which are disposed at one side of the optical film substrate, wherein the optical film substrate is located between the liquid crystal panel and the light sources.

15. The liquid crystal display of claim 14, further comprising:
a case, which has an opening, wherein the optical film substrate is jointed with the opening, the optical film substrate and the case form an accommodating space, and the light sources are disposed in the accommodating space.

16. The liquid crystal display of claim 14, wherein the first surface of the optical film substrate faces to the light sources.

17. The liquid crystal display of claim 14, wherein the second surface of the optical film substrate faces to the light sources.

18. The liquid crystal display of claim 14, wherein each of the Fresnel areas has a focal length.

19. The liquid crystal display of claim 14, wherein each of the light sources is corresponding to one of the Fresnel areas.

20. The liquid crystal display of claim 14, wherein each of the light sources is corresponding to at least one of the Fresnel areas.

21. The liquid crystal display of claim 14, wherein the light sources are a light-emitting diode (LED) array.

22. The liquid crystal display of claim 14, wherein the optical film substrate comprises an optical film and a transparent substrate, and the optical film attaches to the transparent substrate.

23. The liquid crystal display of claim 22, further comprising:
a diffuser, wherein the transparent substrate is located between the optical film and the diffuser.

24. The liquid crystal display of claim 23, wherein the diffuser is disposed adjacent to the transparent substrate.

25. The liquid crystal display of claim 14, further comprising:
a diffuser, wherein the optical film substrate is located between the light sources and the diffuser.

26. The liquid crystal display of claim 25, wherein the diffuser is disposed adjacent to the optical film substrate.
